(19) United States
(12) Patent Application Publication
(10) Pub. No.: US 2007/0126727 A1
(43) Pub. Date: Jun. 7, 2007

(54) METHOD FOR ADJUSTING MONITOR LUMINANCE

(75) Inventor: Ching-Yueh Chiang, Taoyuan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/561,984

(22) Filed: Nov. 21, 2006

(30) Foreign Application Priority Data
Dec. 5, 2005 (TW) 94142830

(51) Int. Cl. G09G 5/00

(52) U.S. Cl. 345/207

(57) ABSTRACT

A method for adjusting monitor luminance applied to a monitor having a light sensor is provided. The method includes the steps of detecting environmental luminance by the light sensor, and adjusting the monitor luminance according to a predetermined monitor luminance adjusting curve and the environmental luminance; determining whether the user selects to adjust the monitor luminance, and obtaining a self-setting monitor luminance adjusting curve according to a user-adjusted monitor luminance and the environmental luminance; adjusting the monitor luminance according to the self-setting monitor luminance adjusting curve and the environmental luminance.

This application claims the benefit of Taiwan application Serial No. 094142830 filed Dec. 5, 2005, the subject matter of which is incorporated herein by reference.

### BACKGROUND OF THE INVENTION

1. Field of the Invention

The invention relates in general to a method for adjusting monitor luminance, and more particularly to a method for adjusting monitor luminance capable of providing user-adjusted monitor luminance by changing monitor luminance adjusting curve.

2. Description of the Related Art

Normally, the monitor has a light sensor for automatically adjusting the luminance difference between the monitor and the environment, lest the user's eyes might develop fatigue easily due to the large difference between monitor luminance and environmental luminance.

Referring to FIG. 1, a luminance adjusting curve of the light sensor of a conventional monitor is shown. The conventional monitor provides the user with a number of predetermined ranges regarding the change in monitor luminance according to a monitor luminance adjusting curve S. For example, the monitor may provide three luminance display regions, namely, low-luminance work area (dark), middle-luminance work area (middle) and high-luminance work area (bright). If the monitor is operated under the low-luminance work area, when the environmental luminance exceeds the limit Le1, the monitor luminance is fixed at Lm1. If the monitor is operated under the middle-luminance work area, when the environmental luminance exceeds the limit Le2, the monitor luminance is fixed at Lm2. If the monitor is operated under high luminance work area, when the environmental luminance exceeds the limit Le3, the monitor luminance is fixed at Lm3. The relationships among the limits of the environmental luminance are:
Le1<Le2<Le3, and the relationships among the monitor luminance are:
Lm1<Lm2<Lm3.

However, the conventional monitor can only provide a number of predetermined luminance display regions and luminance limits and is incapable of respectively adjusting luminance display region and defining monitor luminance adjusting curve according to the environmental luminance at that moment and the user's requirements, largely reducing the user's selection of monitor luminance.

### SUMMARY OF THE INVENTION

The invention is directed to provide a method for adjusting monitor luminance capable of obtaining a self-setting monitor luminance adjusting curve according to the user-adjusted monitor luminance and the environmental luminance defected by the light sensor at that moment. Thus, the invention permits the user to set the monitor luminance adjusting curve and the user-adjusted monitor luminance without being restricted by the number of predetermined luminance display regions. Consequently, the user can set the monitor luminance according to the environmental luminance at that moment and the user's personal preferences and requirements, largely increasing the flexibility and diversity in the setting of monitor luminance.

According to the present invention, a method for adjusting monitor luminance applied to a monitor having a light sensor is provided. The method includes the steps of detecting environmental luminance by the light sensor, and adjusting the monitor luminance according to a predetermined monitor luminance adjusting curve and the environmental luminance; determining whether the user selects to adjust the monitor luminance, and obtaining a self-setting monitor luminance adjusting curve according to a user-adjusted monitor luminance and the environmental luminance; adjusting the monitor luminance according to the self-setting monitor luminance adjusting curve and the environmental luminance.

The invention will become apparent from the following detailed description of the preferred but non-limiting embodiments. The following description is made with reference to the accompanying drawings.

### BRIEF DESCRIPTION OF THE DRAWINGS

FIG. 1 shows a luminance adjusting curve of the light sensor of a conventional monitor;

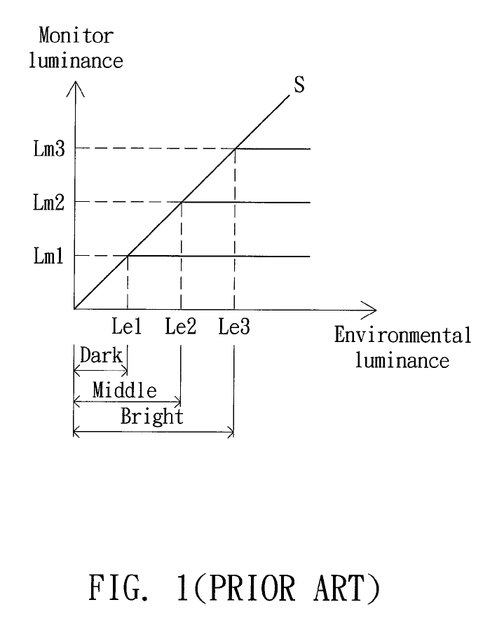

FIG. 2 is a flowchart of a method for adjusting monitor luminance according to a preferred embodiment of the invention;

FIG. 3 is a detailed flowchart of a method for adjusting monitor luminance according to a preferred embodiment of the invention; and

FIG. 4 illustrates an adjustment of a monitor luminance adjusting curve according to a preferred embodiment of the invention.

### DETAILED DESCRIPTION OF THE INVENTION

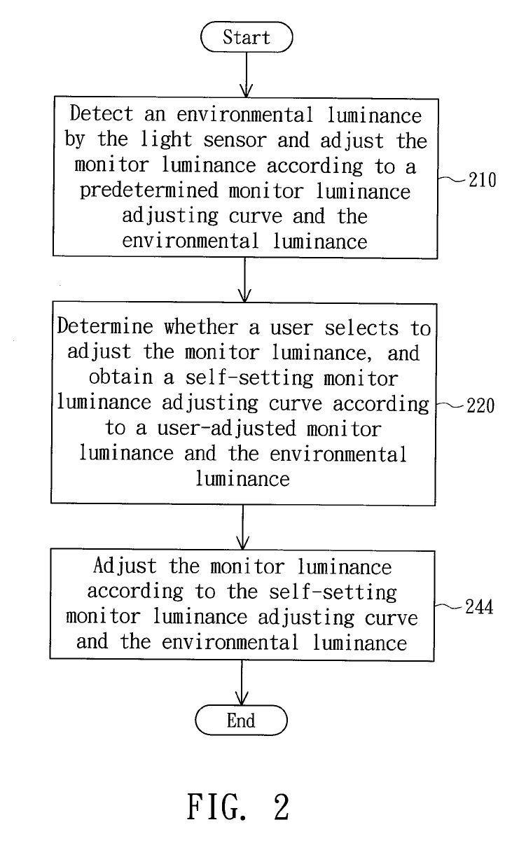

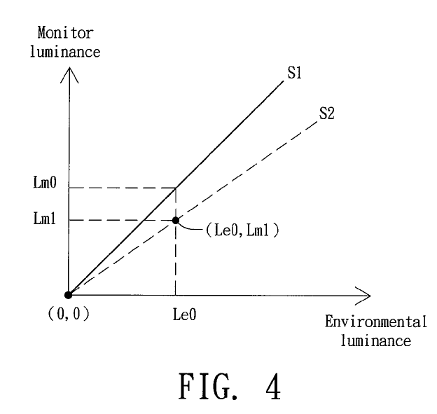

Referring to both FIG. 2 and FIG. 4. FIG. 2 is a flowchart of a method for adjusting monitor luminance according to a preferred embodiment of the invention. FIG. 4 illustrates an adjustment of a monitor luminance adjusting curve according to a preferred embodiment of the invention. Firstly, the method begins at step 210, the monitor detects an environmental luminance Le0 such as 100 lumen at that moment by a light sensor such as a photo resistor sensor, and adjusts the monitor luminance Lm0 such as 90 lumen according to a predetermined monitor luminance adjusting curve S1 and the environmental luminance Le0. The predetermined monitor luminance adjusting curve S1 is recorded in a lookup table of a controller for instance. Next, proceed to step 220, an adjusting menu is displayed according to an on-screen display (OSD) process for the user to determine whether to adjust the monitor luminance. If the user selects not to adjust the monitor luminance, then the monitor displays the luminance according to the predetermined monitor luminance adjusting curve S1 and the environmental luminance detected by the light sensor at that moment. If the user selects to adjust the monitor luminance, for example, the user reduces the monitor luminance to Lm1 of 80 lumen, then the monitor obtains a self-setting monitor luminance adjusting curve S2 according to a user-sdjusted monitor luminance (80 lumen) and the environmental luminance detected by the light sensor at that moment (the original environmental luminance Le0). Thereafter, proceed to step 244, the monitor adjusts the monitor luminance Lm0 according to the self-setting monitor luminance adjusting curve S2 and the environmental luminance Le0. Thus, the monitor can provide the self-setting monitor luminance adjusting curve according to the user-adjusted monitor luminance, such that the user is availed with more convenience and versatility in adjusting monitor luminance.

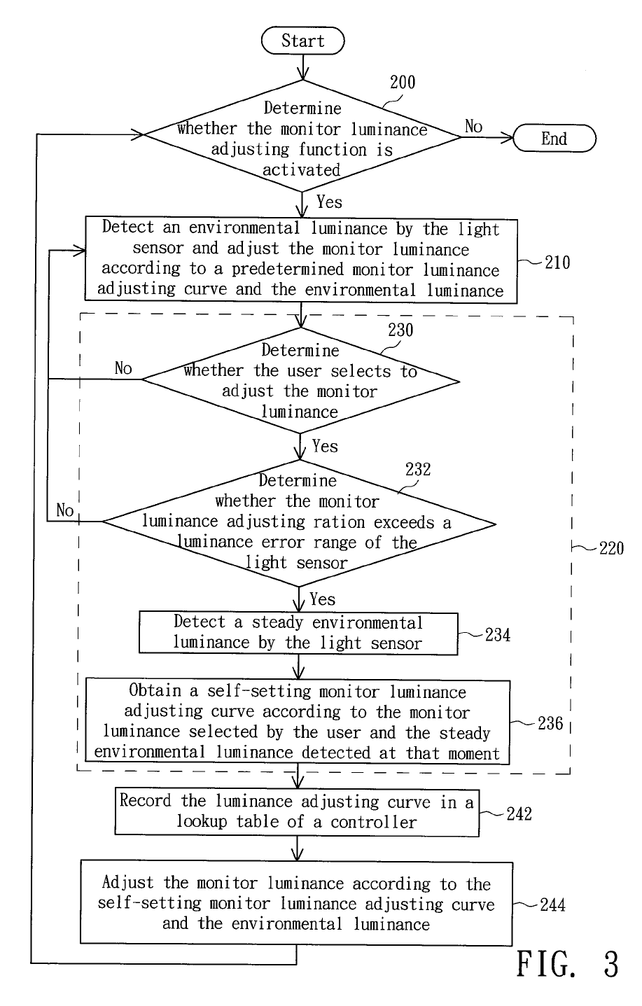

Referring to both FIG. 3 and FIG. 4. FIG. 3 is a detailed flowchart of a method for adjusting monitor luminance according to a preferred embodiment of the invention. Before step 210, the method for adjusting monitor luminance further includes determining whether the monitor luminance adjusting function is activated as shown in step 200: if so, proceed to perform step 210 and step 220, otherwise, the method is terminated. Step 220 further includes steps 230, 232, 234 and 236. In step 230, an adjusting menu is displayed according to the on-screen display (OSD) process for the user to determine whether to adjust the monitor luminance: if not, return to step 210, if so, proceed to step 232, the monitor determines whether the monitor luminance adjusting ration exceeds a luminance error range of the light sensor. If the user selects to reduce the monitor luminance to Lm1 (80 lumen for instance), the monitor will determine whether the monitor luminance adjusting ratio Rm (=(Lm0-Lm1)/Lm0) exceeds the luminance error range of the light sensor (±5% for instance). If the monitor luminance adjusting ratio Rm is within the luminance error range, this implies that the monitor is unable to differentiate the difference between the adjusted monitor luminance Lm1 and the original monitor luminance Lm0 with respect to the change in environmental luminance detected by the light sensor. Thus the method returns to step 210, the monitor luminance is provided according to the predetermined monitor luminance adjusting curve S1 and the environmental luminance detected at that moment. If the monitor luminance adjusting ratio Rm exceeds the luminance error range, for example, Rm=(Lm0-Lm1)/Lm0=(90-80)/90=11% and exceeds the error range of 5%, the method proceeds to step 234, a steady environmental luminance Le0 is detected by the light sensor. Meanwhile, the monitor detects the environmental luminance by the light sensor at that moment until a steady environmental luminance such as an environmental luminance Le0 of 100 lumen is obtained.

Next, proceed to step 236, the monitor obtains a self-setting monitor monitor luminance adjusting curve according to the monitor luminance (Lm1) selected by the user and the steady environmental luminance (Le0) detected at that moment. For example, as shown in FIG. 4, the self-setting monitor luminance adjusting curve S2 is generated according to the coordinate point (Le0, Lm1) and the coordinate origin (0, 0) of the luminance adjusting curve S1. The invention can also generate the above self-setting monitor luminance adjusting curve by curve feeding.

In step 242, when the monitor obtains the self-setting monitor luminance adjusting curve S2 according to the user's requirements, the monitor records the data of the luminance adjusting curve S2 in a lookup table of a controller of the monitor to update the predetermined monitor luminance adjusting curve S1. Lastly, proceed to step 244, the monitor detects the environmental luminance by the light sensor and determines the monitor luminance according to the self-setting monitor luminance adjusting curve S2 recorded in the controller, and proceeds to step 200. In step 200, whether the monitor luminance adjusting function is activated is determined: if so, step 210 is repeated, otherwise, the luminance adjusting function is turned off and the method is terminated. The monitor luminance adjusting curve S2 recorded in the lookup table is the predetermined monitor luminance adjusting curve after the monitor luminance adjusting function is activated next.

According to the method for adjusting monitor luminance of the invention, the self-setting monitor luminance adjusting curve is obtained according to the user-adjusted monitor luminance and the environmental luminance detected by the light sensor at that moment. Thus, the invention permits the user to set the monitor luminance without being restricted by the number of predetermined luminance display regions and the corresponding monitor luminance limits. The monitor luminance is set according to the environmental luminance at that moment and the user's personal preferences and requirements, largely increasing the flexibility and diversity in the setting of monitor luminance.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for adjusting monitor luminance applied to a monitor having a light sensor, the method comprising:
(a) detecting an environmental luminance by the light sensor and adjusting the monitor luminance according to a predetermined monitor luminance adjusting curve and the environmental luminance; and
(b) determining whether a user selects to adjust the monitor luminance: if so, obtain a self-setting monitor luminance adjusting curve according to a user-adjusted monitor luminance and the environmental luminance;
(c) adjusting the monitor luminance according to the self-setting monitor luminance adjusting curve and the environmental luminance.

2. The method according to claim 1, wherein step (b) further comprises displaying a menu on the monitor according to an on-screen display (OSD) process for the user to determine whether to adjust the monitor luminance.

3. The method according to claim 1, wherein step (b) further comprises:
(b-1) determining whether the adjusting ratio between the user-adjusted monitor luminance and the original monitor luminance exceeds a luminance error range of the light sensor: if not, proceed to step (a);
(b-2) detecting and obtaining a steady environmental luminance by the light sensor; and
(b-3) obtaining the self-setting monitor luminance adjusting curve according to the user-adjusted monitor luminance and the steady environmental luminance detected at that moment.

4. The method according to claim 3, wherein the luminance error range is approximately ±5%.

5. The method according to claim 1, wherein the self-setting monitor luminance adjusting curve is generated by curve feeding.

6. The method according to claim 1, wherein the self-setting monitor luminance adjusting curve is a straight line generated according to a coordinate point (an environmental luminance, a user-setting monitor luminance) and a coordinate origin of the predetermined monitor luminance adjusting curve.

7. The method according to claim 1 further comprises
(a-0) determining whether the monitor luminance adjusting function is activated: if so, proceed to step (a), otherwise, terminate the method.

8. The method according to claim 7, wherein the monitor further comprising a controller and the step (c) further comprises:
(c-1) recording the self-setting monitor luminance adjusting curve in a lookup table of the controller; and
(c-2) detecting the environmental luminance by the light sensor, adjusting the monitor luminance according to the self-setting monitor luminance adjusting curve recorded in the controller, and proceeding to step (a-0).

9. The method according to claim 8, wherein the predetermined monitor luminance adjusting curve is recorded in the lookup table of the controller and step (c-1) comprises recording the self-setting monitor luminance adjusting curve in the lookup table to update the predetermined monitor luminance adjusting curve.

10. The method according to claim 9, wherein the updated monitor luminance adjusting curve recorded in the lookup table is the predetermined monitor luminance adjusting curve after the monitor luminance adjusting function is activated next.
